(19) United States
(12) Patent Application Publication
(10) Pub. No.: US 2014/0283341 A1
(43) Pub. Date: Sep. 25, 2014

(54) CABLE CLAMP

(71) Applicants: HONG FU JIN PRECISION INDUSTRY (ShenZhen) CO., LTD., (US); HON HAI PRECISION INDUSTRY CO., LTD., New Taipei (TW)

(72) Inventors: WU ZHOU, Shenzhen (CN); JUN-HUI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/851,084

(22) Filed: Mar. 26, 2013

(30) Foreign Application Priority Data
Mar. 19, 2013 (CN) 201310086629.8

(51) Int. Cl. F16L 3/12

(52) U.S. Cl. CPC F16L 3/12
USPC 24/16 R

(57) ABSTRACT

A cable clamp to be mounted to an installation board includes a binding portion, and a first sandwiching portion and a second sandwiching portion connected to the binding portion and capable of sandwiching the installation board.

### BACKGROUND

1. Technical Field

The present disclosure relates to a cable clamp.

2. Description of Related Art

Cable clamps used to bind cables are generally stuck to a sidewall of a computer enclosure with adhesive. However, it is difficult to disengage those cable clamps from the enclosure when needed, and furthermore, the adhesive may be damaged, causing the cable clamps no longer reusable. Therefore, there is improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a cable clamp, together with a chassis.

FIG. 2 is an enlarged view of the cable clamp of FIG. 1, but viewed from another perspective.

FIG. 3 is an assembled view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

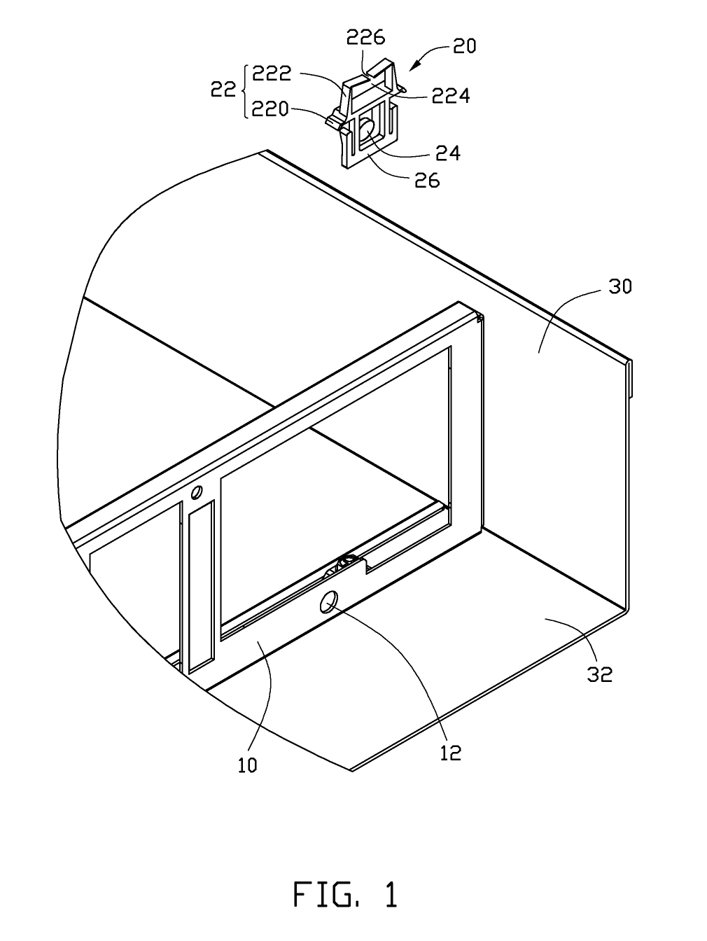

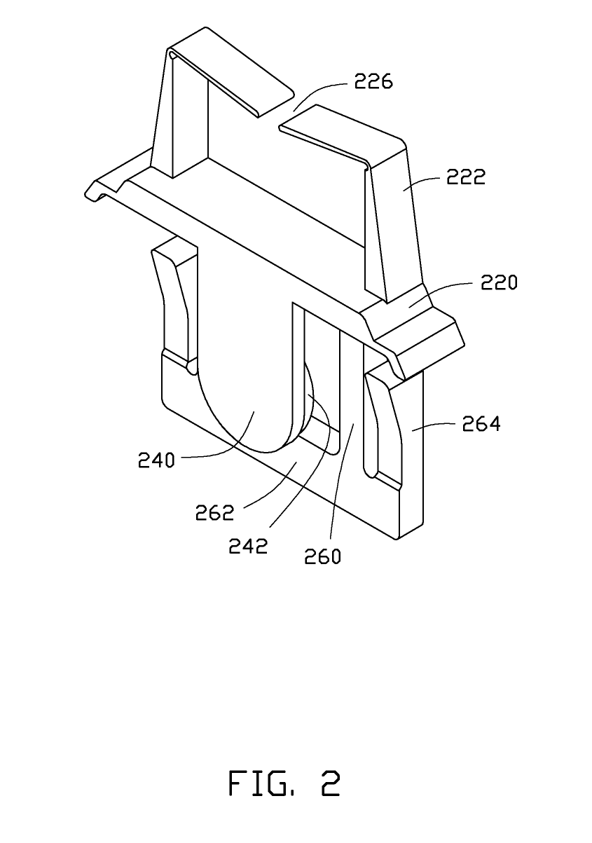

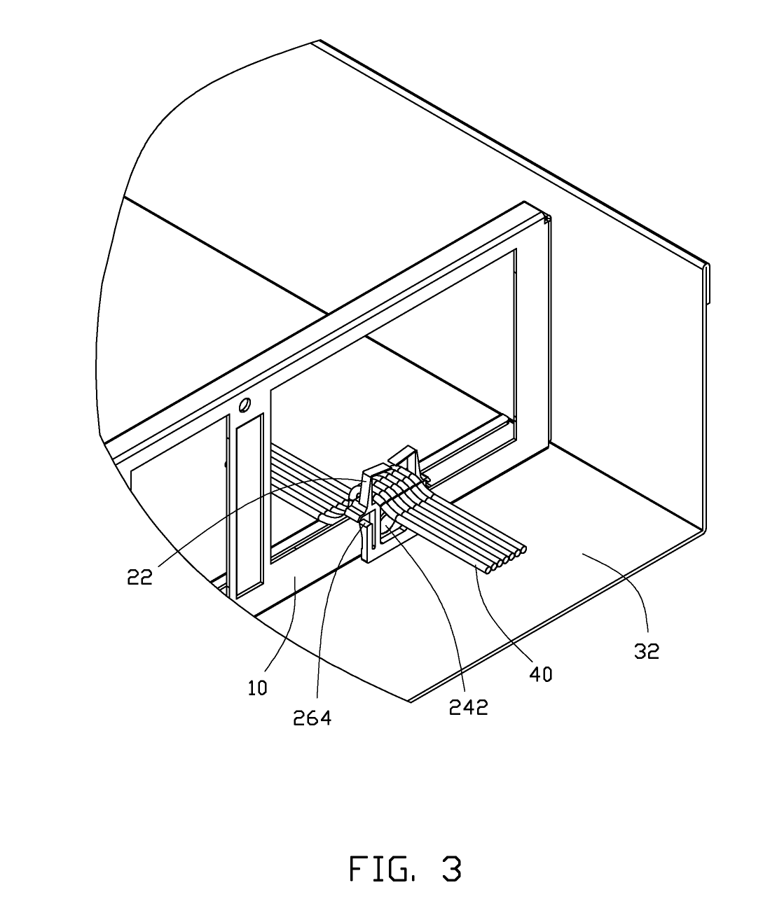

Referring to FIGS. 1 and 2, an exemplary embodiment of a cable clamp 20 is provided for binding cables 40 (shown in FIG. 3). The cable clamp 40 is mounted to an installation board 10 which is perpendicularly extended up from a bottom wall 32 of a chassis 30. The installation board 10 defines a through hole 12.

The cable clamp 20 includes a binding portion 22, a resilient first sandwiching portion 24, and a resilient second sandwiching portion 26.

The binding portion 22 includes a connecting bar 220 and a receiving portion 222 connected to a top surface of the connecting bar 220. A receiving space 224 in which the cables 40 are received is bounded by the connecting bar 220 and the receiving portion 222. The receiving portion 222 defines an opening 226 communicating with the receiving space 224. The cables 40 can enter or move out of the receiving space 224 through the opening 26.

The first sandwiching portion 24 includes a resilient extension piece 240 perpendicularly extending down from a rear side of a bottom surface of the connecting bar 220 opposite to the binding portion 22. A protrusion 242 protrudes from a front surface of the extension piece 240.

The second sandwiching portion 26 includes two arms 260 perpendicularly extending down from a front side of the bottom surface of the connecting bar 220, a rib 262 perpendicularly connected between bottom ends of the arms 260, and two L-shaped resilient portions 264 perpendicularly extending out from bottom ends of the arms 260 and then perpendicularly extending up toward the connecting bar 220. Tops of the resilient portions 264 protrude toward the first sandwiching portion 24.

Referring to FIG. 3, in assembly, the cable clamp 20 is mounted to the installation board 10 as shown. The extension piece 240 and the second sandwiching portion 26 are deformed away from each other to sandwich the installation board 10 and slide along opposite sides of the installation board 10, until the protrusion 242 is engaged in the through hole 12. The top ends of the resilient portions 264 abut against a corresponding one of the opposite sides of the installation board 10.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A cable clamp to be mounted to an installation board, the cable clamp comprising:
a binding portion to clamp cables; and
a first sandwiching portion and a second sandwiching portion connected to a side of the binding portion to sandwich the installation board.

2. The cable clamp of claim 1, wherein the binding portion comprises a connecting bar and a receiving portion connected to another side of the connecting bar, a receiving space in which the cables are to be received is bounded by the connecting bar and the receiving portion, the receiving portion defines an opening communicating with the receiving space.

3. The cable clamp of claim 2, wherein the second sandwiching portion comprises an arm perpendicularly extending from the connecting bar and a resilient portion extending out from the arm and then extending up toward the connecting bar.

4. The cable clamp of claim 2, wherein the first sandwiching portion comprises a resilient extension piece perpendicularly extending from the connecting bar, a protrusion protrudes from the extension piece toward the second sandwiching portion.

5. The cable clamp of claim 4, wherein the second sandwiching portion comprises two arms perpendicularly extending from the connecting bar and a rib connected between the arms.

6. The cable clamp of claim 4, wherein the second sandwiching portion further comprises two resilient portions extending out from the arms and then extending up toward the connecting bar, tops of the resilient portions protrude toward the first sandwiching portion.
